(19) United States
(12) Patent Application Publication
(10) Pub. No.: US 2024/0312087 A1
(43) Pub. Date: Sep. 19, 2024

(54) CUSTOM CONTENT GENERATION

(71) Applicant: ADOBE INC., SAN JOSE, CA (US)

(72) Inventors: Shradha Agrawal, Milpitas, CA (US); Debraj Debashish Basu, Sunnyvale, CA (US); Deepak Pai, Sunnyvale, CA (US); Nimish Srivastav, Santa Clara, CA (US); Meghanath Macha, San Jose, CA (US); Ambareesh Revanur, San Jose, CA (US)

(21) Appl. No.: 18/360,919

(22) Filed: Jul. 28, 2023

Related U.S. Application Data
(60) Provisional application No. 63/490,937, filed on Mar. 17, 2023.

(51) Int. Cl. G06T 11/60; G06F 40/186; G06F 40/40; G06Q 30/0241; G06T 7/90

(52) U.S. Cl. CPC G06T 11/60; G06F 40/186; G06F 40/40; G06Q 30/0276; G06T 7/90; G06T 2207/10024; G06T 2207/20081

(57) ABSTRACT

Systems and methods for document processing are provided. One aspect of the systems and methods includes identifying a theme and an input image of a product. Another aspect of the systems and methods includes generating an output image depicting the product and the theme based on the input image using an image generation model that is trained to generate images consistent with a brand. Another aspect of the systems and methods includes generating text based on the product and the theme using a text generation model. Another aspect of the systems and methods includes generating custom content consistent with the brand and the theme based on the output image and the text.

### CROSS-REFERENCE TO RELATED APPLICATION

This application claims priority to, and the benefit of, U.S. Provisional Application Ser. No. 63/490,937 filed on Mar. 17, 2023, entitled CUSTOM CONTENT GENERATION. The entire contents of the foregoing application are hereby incorporated by reference for all purposes.

### BACKGROUND

The following relates generally to machine learning, and more specifically to machine learning for content generation. Content generation is the process of creating various types of content, such as articles, blog posts, videos, podcasts, infographics, social media posts, and more. The content generation process can involve researching, planning, creating, and publishing content that is relevant, informative, engaging, and useful to the intended audience. Creators organize their ideas, gather relevant information to support their ideas, and select a format for distributing the information. Creators then create content including the information based on the selected format, and creators publish and distribute the content through various channels, such as social media, email, or a company's website.

### SUMMARY

The present disclosure describes systems and methods for content generation. Embodiments of the present disclosure include a content generation apparatus configured to generate content including a product image based on a theme provided by a user. The content generation apparatus obtains a source of product images from the user, and the content generation apparatus selects a product image from the source. The content generation apparatus modifies the product image based on the theme provided by the user.

In some cases, the content generation apparatus also generates text related to the product image based on the theme and source text content (e.g., a product description, brand voice, etc.) provided by the user. Once the product image and the text are finalized, the content generation apparatus generates custom content including the product image and the text. In some examples, the content generation apparatus transmits the custom content to consumers in an email (e.g., as part of a content campaign).

A method, apparatus, non-transitory computer readable medium, and system for machine learning for content generation are described. One or more aspects of the method, apparatus, non-transitory computer readable medium, and system include identifying a theme, an audience, and an input image of a product; generating, for the audience, an output image depicting the product and the theme based on the input image using an image generation model that is trained to generate images consistent with a brand; generating text based on the product and the theme using a text generation model; and generating custom content consistent with the brand and the theme based on the output image and the text.

A method, apparatus, non-transitory computer readable medium, and system for machine learning for content generation are described. One or more aspects of the method, apparatus, non-transitory computer readable medium, and system include obtaining training data including brand consistency data; generating an output image depicting a product using an image generation model; and updating parameters of the image generation model based on the brand consistency data and the output image.

An apparatus, system, and method for machine learning for content generation are described. One or more aspects of the apparatus, system, and method include at least one memory component; at least one processing device coupled to the at least one memory component, wherein the processing device is configured to execute instructions stored in the at least one memory component; an image generation model including parameters stored in the at least one memory component and configured to generate an output image depicting a product and a theme, wherein the image generation model is trained to generate images consistent with a brand; and a text generation model including parameters stored in the at least one memory component and configured to generate text based on the product and the theme.

### BRIEF DESCRIPTION OF THE DRAWINGS

FIG. 1 shows an example of a content generation system according to aspects of the present disclosure.

FIG. 2 shows an example of a content generation apparatus according to aspects of the present disclosure.

FIG. 3 shows an example of communications between components of a content generation system according to aspects of the present disclosure.

FIG. 4 shows an example of content generation according to aspects of the present disclosure.

FIG. 5 shows an example of a guided latent diffusion model according to aspects of the present disclosure.

FIG. 6 shows an example of a method for content generation according to aspects of the present disclosure.

FIGS. 7 through 9 show examples of methods for machine learning according to aspects of the present disclosure.

FIG. 10 shows an example of a method for training a diffusion model according to aspects of the present disclosure.

### DETAILED DESCRIPTION

The present disclosure relates to systems and methods for generating custom content. According to various embodiments, the custom content can be generated using a machine learning model that can automatically generate content based on a theme and consistent with brand guidelines.

Content generation includes the creation of articles, blog posts, videos, podcasts, infographics, social media posts, and more. The content generation process can involve multiple stages such as researching, planning, creating, and publishing. The content can distributed through various channels, such as social media, email, or a website. The content generation process can be costly, and in some cases, undesirable content can be created that does not match target guidelines such as branding guidelines.

For example, creating effective email campaigns can be a laborious and time-consuming process for content providers. Creating these campaigns often involves coordination between content creators (e.g., technical writers and designers) and can involve large turnaround times. Content providers create different kinds of campaigns based on seasonal themes (e.g., holidays) or content objectives (e.g., customer acquisition, retention). While some elements of a campaign remain constant (e.g., products and a landing page), in some cases it is appropriate to change other elements of the campaign (e.g., the background of a hero image, an email subject line, etc.). Even with a small number of variables and a small number of options for each variable, the combinations of values for the variables can grow exponentially. Evaluating such a large number of combinations of content fragments can be resource intensive.

According to some aspects of the present disclosure, a content generation apparatus uses machine learning to generate content based on inputs (e.g., text and images) that is related to a target theme (e.g., a season or an event) and consistent with target guidelines (e.g., color schemes, inoffensive content, etc.). Some embodiments of the content generation apparatus include an image generation model, a text generation model, and a content generation component.

In some aspects, the content generation apparatus identifies a theme and an input image of a product. In some aspects, the image generation model generates an output image depicting the product and the theme based on the input image. The image generation model is trained to generate images consistent with a brand. In some aspects, the text generation model generates text based on the product and the theme. In some aspects, the content generation component generates custom content consistent with the brand and the theme based on the output image and the text.

By generating the output image depicting the product and the theme based on the input image, the image generation model can generate an image that is appropriate for an occasion (e.g., holiday, company event) while still effectively depicting a product in the image. By generating the text based on the product and the theme, the text generation model can generate text that is appropriate for an occasion while still effectively describing a product. By generating content consistent with a brand and a theme based on the output image and the text, the content generation component can combine images and text to produce content that is suitable for a particular brand while still effectively depicting and describing a product.

In one example, a content provider uses the content generation apparatus to generate custom content (e.g., an email) featuring a product for a content campaign. The content provider provides a theme, an image source, or a text source (e.g., product description) to the content generation apparatus, and the content generation apparatus generates custom content based on the theme, the image source, or the text source. The custom content includes a product image from the image source and text generated based on the theme. The content generation apparatus transmits the custom content to the content provider, and the content provider verifies that the custom content is appropriate for distribution. If the content provider determines that the custom content is appropriate for distribution, the content generation apparatus distributes the custom content. Otherwise, the content provider requests additional renditions of the custom content from the content generation apparatus.

As used herein, “custom content” refers to content that is customized based on inputs provided by a content provider (e.g., an influencer, an author, an entrepreneur, a marketer, etc.). In some examples, the content can be customized based on a theme provided by a user or based on a product image retrieved from an image source provided by a user.

As used herein, a “coverage score” refers to a score assigned to an image that specifies a level of coverage of a product in the image. A higher coverage score is assigned to images that cover or show more aspects of a product, and a lower coverage score is assigned to images that cover or show less aspects of a product. For example, an image showing the entirety of a jacket receives a higher coverage score than an image zoomed in on a logo on the back of the jacket.

As used herein, a “compellingness score” refers to a score assigned to an image that specifies how compelling the image is to customers. The compellingness score is referred to as an intrinsic image popularity score. In some examples, the compellingness of an image relates to a level of engagement (e.g., number of comments and likes) that an image would be expected to receive on a social media platform (e.g., as determined by a machine learning model trained to associate a level of engagement with an image).

As used herein, content that is “consistent with a brand” refers to content that passes, satisfies, or follows a set of brand guidelines provided for a brand. In some examples, brand guidelines mandate or prohibit the inclusion of specific colors, objects, or other features in the images of generated content. Brand guidelines may also have similar mandates or prohibitions for text-related aspects of generated content (e.g., related to the inclusion of certain language). Additionally, or alternatively, content that is “consistent with a brand” can refer to content that is similar to other content that is previously determined to be suitable or appropriate for the brand (e.g., as determined by a machine learning model trained to identify a level of similarity between different content).

As used herein, “brand consistency data” refers to data that is used to determine if content is consistent with a brand or data used to train models to generate content that is consistent with a brand. In some cases, brand consistency data includes brand guidelines or examples of content that is suitable for a brand. A “brand consistency value” refers to a value assigned to content that specifies a level of consistency with a brand.

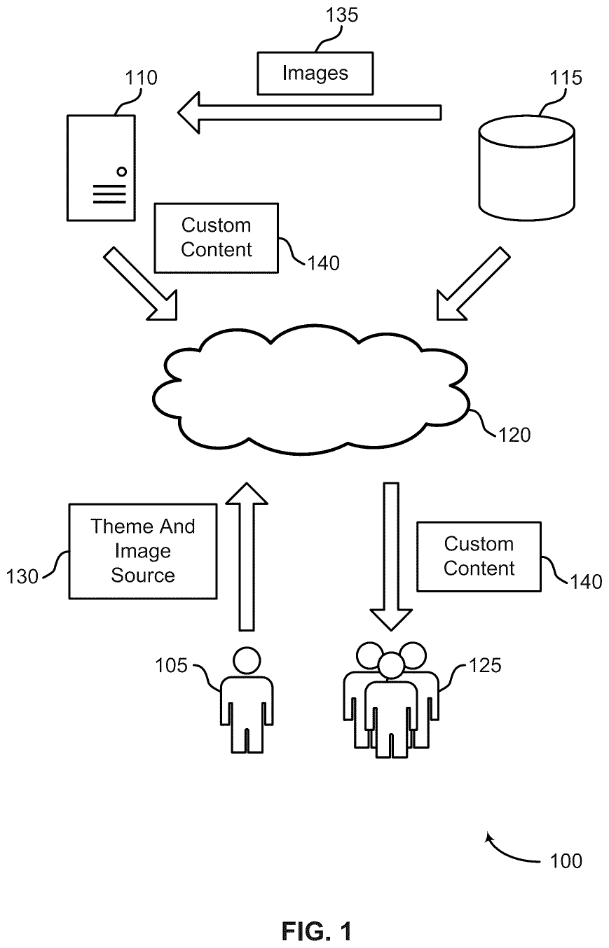

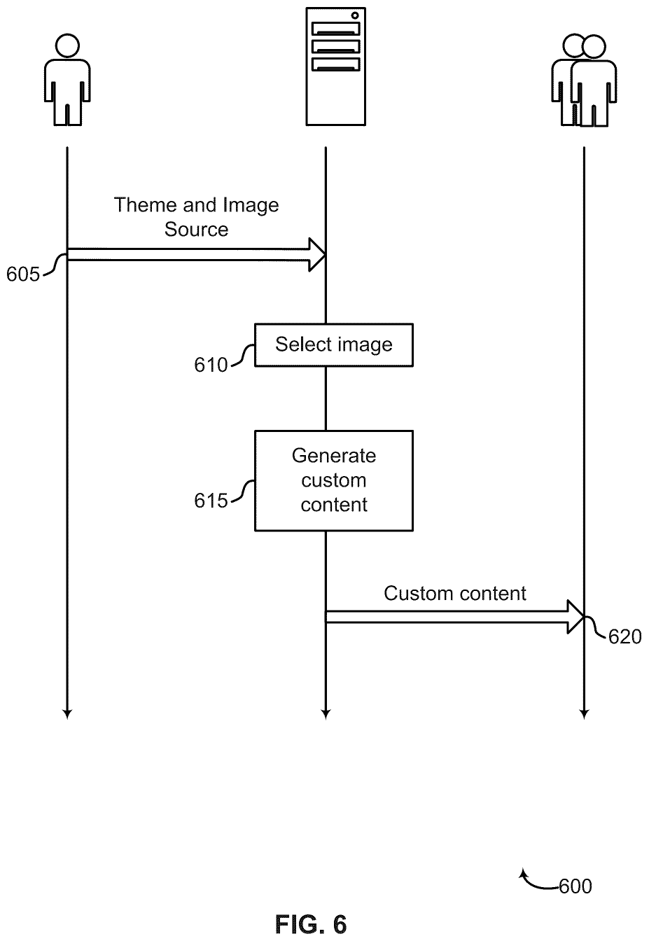

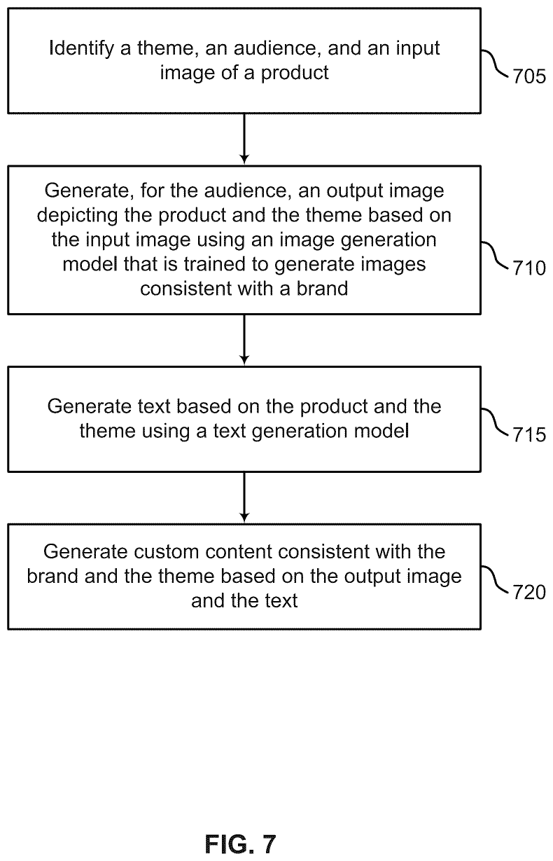

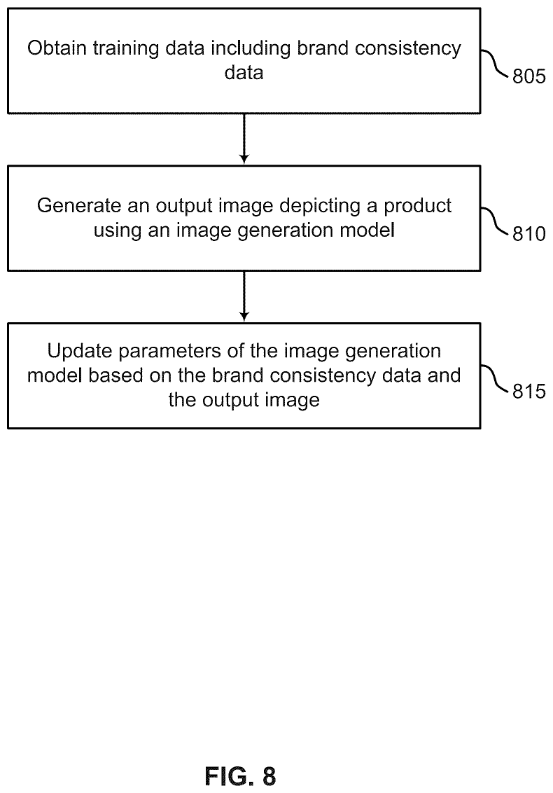

Details regarding the architecture of an example content generation apparatus are provided with reference to FIGS. 1-5. Example processes for content generation are provided with reference to FIGS. 6 and 7. Example training processes are described with reference to FIGS. 8-10.

### Network Architecture

In FIGS. 1-5, a system for machine learning for content generation is described. The system includes at least one memory component; at least one processing device coupled to the at least one memory component, wherein the processing device is configured to execute instructions stored in the at least one memory component; an image generation model including parameters stored in the at least one memory component and configured to generate an output image depicting a product and a theme, wherein the image generation model is trained to generate images consistent with a brand; and a text generation model including parameters stored in the at least one memory component and configured to generate text based on the product and the theme.

In some aspects, the system includes a content generation component configured to generate custom content consistent with the brand and the theme based on the output image and the text. In some aspects, the system includes an image selection model configured to select an input image of the product from a plurality of images, wherein the output image is generated based on the input image. In some aspects, the system includes a moderation model configured to identify brand guidelines and determine whether the text or the image is consistent with the brand based on the brand guidelines.

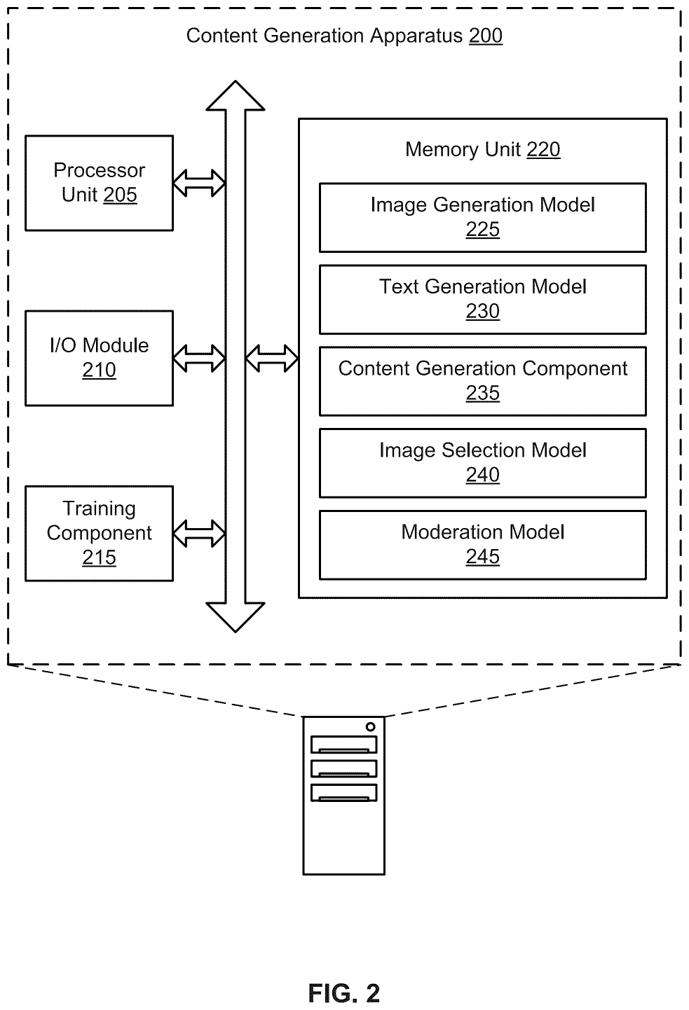

FIG. 1 shows an example of a content generation system 100 according to aspects of the present disclosure. In one aspect, content generation system 100 includes user 105, content generation apparatus 110, database 115, cloud 120, and consumers 125. Content generation apparatus 110 is an example of, or includes aspects of, the corresponding element described with reference to FIG. 2.

The present disclosure describes systems and methods for content generation. Embodiments of the present disclosure include a content generation apparatus 110 configured to generate content including a product image based on a theme provided by a user 105. A user 105 interacts with a content generation apparatus 110 via a user device. The user device communicates with the content generation apparatus 110 via the cloud 120. In some examples, the user 105 provides a theme and an image source 130 to the content generation apparatus 110 via the user device, and the content generation apparatus 110 retrieves images 135 from a database 115 based on the image source. The content generation apparatus 110 selects an image from the images 135, and the content generation apparatus 110 generates custom content 140 based on the selected image and the theme provided by the user 105. The content generation apparatus 110 then sends the custom content 140 to the consumers 125 (e.g., in response to a command from the user 105).

In an example, the custom content 140 is an email, and the content generation apparatus 110 generates text for the email and generate an image representing a product for the email. Given an image source (e.g., a landing page uniform resource locator (URL)) and a theme for an email campaign (e.g., time of year, company event, target audience, etc.), the content generation apparatus 110 generates a subject line, a catchphrase, and a one-line product summary for the email. In some examples, the content generation apparatus 110 conditions a large language model (LLM) for text generation. For instance, the FLAN-T5 model is adapted (e.g., with fewer than 100 examples) for generative tasks across both long text forms (e.g., a product summary) and short text forms (e.g., catchphrases and subject lines). According to one embodiment, the FLAN-T5 model has the same parameters (e.g., be initialized with the same parameters) as a T5 model and is fine-tuned on more than 1000 additional tasks.

According to an embodiment, the content generation apparatus 110 includes a FLAN-T5 model which are fine-tuned further by following a fixed template in training data for generating each type of text for an email. For instance, for catchphrase generation, a template for training data includes a product name, product description, and a content theme as inputs and a catchphrase as output. Then, during inference, a catchphrase generation model is prompted with a product name, product description, and a content theme to generate a catchphrase. Similar templates is used for subject line and product summary generation. In some examples, the content generation apparatus 110 is configured to generate multiple catchphrases with a same prompt separated by a filler word, or the content generation apparatus 110 is configured for combined generation of a catchphrase and a one-line product summary for additional coherence in generation.

In some examples, training data is generated using multiple pre-trained models. In some examples, diffusion models is used to edit images via text prompts. Training data is generated for each sub-problem to be solved by the content generation apparatus 110 (e.g., using a generative model trained for conversation). A sub-problem refers to a different aspect of custom content to be generated by the content generation apparatus 110. For instance, one sub-problem is to generate a subject line, another sub-problem is to generate a product summary, another sub-problem is to generate a catchphrase, and another sub-problem is to generate a background for a hero image.

In an example, to generate an instance of training data for catchphrase generation, a generative model is prompted with a request such as “Can you give us a catchy phrase for this product <product_name> and description <product_description>?” where <product_name> corresponds to a name of a product and <product_description> corresponds to a description of the product. Further, to generate a catchphrase that is styled based on a content theme, an additional prompt is provided to the generative model, such as “Can you style the phrase for the occasion <content_theme>?” where <content_theme> corresponds to a content theme for a campaign. Thus, a fixed template for fine-tuning a generative model (e.g., FLAN) to generate catch phrases includes a <product_name> input, a <product_description> input, a <content_theme> input, and an <output> corresponding to the output of the generative model. For subject line generation, a sentence prompt is used for generation. For instance, to generate a subject line for an email on a certain occasion, the following sentence prompt is provided to a generative model: “generate one short, exciting email subject line from {brand} on {occasion}.” Each generative model of the content generation apparatus 110 is fine-tuned with multiple (e.g., 100) examples.

In some examples, the content generation apparatus 110 includes a server. A server provides one or more functions to users (e.g., a user 105) linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

A database 115 is an organized collection of data. For example, a database 115 stores data in a specified format known as a schema. A database 115 is structured as a single database, a distributed database, multiple distributed databases, or an emergency backup database. In some cases, a database controller manages data storage and processing in a database. In some cases, a user 105 interacts with a database controller. In other cases, a database controller operates automatically without user interaction.

A cloud 120 is a computer network configured to provide on-demand availability of computer system resources, such as data storage and computing power. In some examples, the cloud 120 provides resources without active management by the user 105. The term “cloud” is sometimes used to describe data centers available to many users over the Internet. Some large cloud networks have functions distributed over multiple locations from central servers. A server is designated an edge server if the server has a direct or close connection to a user. In some cases, a cloud 120 is limited to a single organization. In other examples, the cloud 120 is available to many organizations. In one example, a cloud 120 includes a multi-layer communications network comprising multiple edge routers and core routers. In another example, a cloud 120 is based on a local collection of switches in a single physical location.

A user device (e.g., a computing device) is a personal computer, laptop computer, mainframe computer, palmtop computer, personal assistant, mobile device, or any other suitable processing apparatus.

FIG. 2 shows an example of a content generation apparatus 200 according to aspects of the present disclosure. Content generation apparatus 200 is an example of, or includes aspects of, the corresponding element described with reference to FIG. 1. In one aspect, content generation apparatus 200 includes processor unit 205, I/O module 210, training component 215, and memory unit 220. In one aspect, memory unit 220 includes image generation model 225, text generation model 230, content generation component 235, image selection model 240, and moderation model 245. For instance, parameters for image generation model 225, text generation model 230, content generation component 235, image selection model 240, and moderation model 245 is stored in the memory unit 220.

Processor unit 205 comprises a processor. Processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 205 is configured to operate a memory array using a memory controller. In other cases, a memory controller is integrated into the processor unit 205. In some cases, the processor unit 205 is configured to execute computer-readable instructions stored in a memory to perform various functions. In some embodiments, a processor unit 205 includes special-purpose components for modem processing, baseband processing, digital signal processing, or transmission processing.

I/O module 210 (e.g., an input/output interface) includes an I/O controller. An I/O controller manages input and output signals for a device. I/O controller can also manage peripherals not integrated into a device. In some cases, an I/O controller represents a physical connection or port to an external peripheral. In some cases, an I/O controller utilizes an operating system such as iOS®, ANDROID®, MS-DOS®, MS-WINDOWS®, OS/2®, UNIX®, LINUX®, or another known operating system. In other cases, an I/O controller represents or interacts with a modem, a keyboard, a mouse, a touchscreen, or a similar device. In some cases, an I/O controller is implemented as part of a processor. In some cases, a user interacts with a device via I/O controller or via hardware components controlled by an I/O controller.

In some examples, I/O module 210 includes a user interface. A user interface enables a user to interact with a device. In some embodiments, the user interface includes an audio device, such as an external speaker system, an external display device such as a display screen, or an input device (e.g., remote-control device interfaced with the user interface directly or through an I/O controller module). In some cases, a user interface is a graphical user interface (GUI). In some examples, a communication interface operates at the boundary between communicating entities and the channel and also records and processes communications. Communication interface is provided herein to enable a processing system coupled to a transceiver (e.g., a transmitter and/or a receiver). In some examples, the transceiver is configured to transmit (or send) and receive signals for a communications device via an antenna.

Memory unit 220 comprises a memory including instructions executable by the processor. Examples of a memory unit 220 include random access memory (RAM), read-only memory (ROM), or a hard disk. Examples of memory units 220 include solid state memory and a hard disk drive. In some examples, memory is used to store computer-readable, computer-executable software including instructions that, when executed, cause a processor to perform various functions described herein. In some cases, the memory unit 220 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 220 store information in the form of a logical state.

In some examples, content generation apparatus 200 includes a computer-implemented artificial neural network (ANN) to generate classification data for a set of samples. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. Each node and each edge is associated with one or more node weights that determine how the signal is processed and transmitted.

In some examples, content generation apparatus 200 includes a computer-implemented convolutional neural network (CNN). A CNN is a type of neural network that is commonly used in computer vision or image classification systems. In some cases, a CNN enables processing of digital images with minimal pre-processing. A CNN is characterized by the use of convolutional (or cross-correlational) hidden layers. These layers apply a convolution operation to the input before signaling the result to the next layer. Each convolutional node processes data for a limited field of input (i.e., the receptive field). During a forward pass of the CNN, filters at each layer is convolved across the input volume, computing the dot product between the filter and the input. During the training process, the filters is modified so that they activate when they detect a particular feature within the input.

In some examples, content generation apparatus 200 includes a transformer. A transformer or transformer network is a type of neural network model used for natural language processing tasks. A transformer network transforms one sequence into another sequence using an encoder and a decoder. The encoder and decoder include modules that can be stacked on top of each other multiple times. The modules comprise multi-head attention and feedforward layers. The inputs and outputs (target sentences) are first embedded into an n-dimensional space. Positional encoding of the different words (i.e., give every word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves query, keys, and values denoted by Q, K, and V, respectively. Q corresponds to a matrix that contains the query (vector representation of one word in the sequence), K corresponds to all the keys (vector representations of all the words in the sequence), and V corresponds to the values, which are again the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights Wₐₜₜₙ.

In some examples, the training component 215 is implemented as software stored in memory and executable by a processor of a separate computing device, as firmware in the separate computing device, as one or more hardware circuits of the separate computing device, or as a combination thereof. In some examples, training component 215 is part of another apparatus other than content generation apparatus 200 and communicates with the content generation apparatus 200.

In some examples, the image generation model 225 comprises a diffusion model. Diffusion models are a class of generative neural networks which can be trained to generate new data (e.g., novel images) with features similar to features found in training data. Diffusion models can be used for various image generation tasks including image super-resolution, generation of images with perceptual metrics, conditional generation (e.g., generation based on text guidance), image inpainting, and image manipulation. Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic and faster process so that the same input results in the same output. Diffusion models are also be characterized by whether the noise is added to the image itself, or to image features generated by an encoder (i.e., latent diffusion).

In some examples, the text generation model 230 comprises a text-to-text transfer transformer (T5) model. T5 is a transformer-based architecture trained to perform text-to-text operations. Various tasks, such as translation, text classification, and question answering, are posed as text-to-text tasks where a T5 model takes model text as input and generates some target text. One enhancement of the T5 model is a fine-tuned language net (FLAN) T5 (FLAN-T5) model. The FLAN-T5 model includes the same number of parameters as a T5 model but is fine-tuned on additional tasks incorporating more languages (e.g., more than 1000 additional tasks covering more languages). For instance, the FLAN-T5 model is fine-tuned on a multi-task mixture of unsupervised and supervised tasks. The FLAN-T5 model is used to perform various natural language processing tasks, such as text generation, language translation, sentiment analysis, and text classification.

In some examples, the image selection model 240 evaluates images using a multimodal encoder, such as a contrastive language-image pre-training (CLIP) encoder. CLIP is a neural network-based model that is trained on a massive dataset of images and text (e.g., image captions). CLIP uses a technique called contrastive learning to learn underlying patterns and features of data. Contrastive learning allows CLIP to understand the relationships between different objects and scenes in images, and to classify them based on their content. CLIP is multimodal in that it can process and understand multiple types of data inputs, such as text and images. In some examples, CLIP can be fine-tuned for specific tasks, such as recognizing specific objects in images. CLIP's ability to generalize from one task to another and to be fine-tuned for new tasks makes it a highly versatile model.

According to some aspects, content generation apparatus 200 identifies a theme (e.g., provided as an input by a user), an audience, and an input image of a product. According to some aspects, image generation model 225 generates, for the audience, an output image depicting the product and the theme based on the input image. Image generation model 225 is trained to generate images consistent with a brand. In some aspects, the output image includes a custom background based on the theme. According to some aspects, text generation model 230 generates text based on the product and the theme. In some aspects, the text includes a subject line, a catchphrase, a product summary, or any combination thereof. According to some aspects, content generation component 235 generates custom content consistent with the brand and the theme based on the output image and the text.

According to some aspects, image selection model 240 obtains a set of images of the product. In some examples, image selection model 240 selects the input image from the set of images. In some examples, image selection model 240 computes a coverage score. In some examples, image selection model 240 computes a compellingness score, where the input image is selected based on the coverage score and the compellingness score. In some examples, image selection model 240 identifies a product website, where the set of images are obtained from the product website.

In some examples, content generation component 235 identifies a document template, where the custom content is generated based on the document template. In some examples, content generation apparatus 200 transmits the custom content to a user in an email. According to some aspects, moderation model 245 identifies brand guidelines. In some examples, moderation model 245 determines whether the custom content is consistent with the brand based on the brand guidelines.

According to some aspects, training component 215 obtains training data including brand consistency data. According to some aspects, image generation model 225 generates an output image depicting a product. In some examples, training component 215 updates parameters of the image generation model 225 based on the brand consistency data and the output image.

In some examples, training component 215 identifies a color in the output image (e.g., and other parameters in the output image, such as composition rules). In some examples, training component 215 generates a brand consistency value based on the color (e.g., and the other parameters) and the brand consistency data, where the parameters of the image generation model 225 are updated based on the brand consistency value. In some examples, training component 215 identifies an object in the output image. In some examples, training component 215 generates a brand consistency value based on the object and the brand consistency data, where the parameters of the image generation model 225 are updated based on the brand consistency value. In some examples, image generation model 225 identifies a theme, where the output image is generated based on the theme.

In some examples, training component 215 trains the text generation model 230 to generate text based on the product and the theme. In some examples, training component 215 identifies language in output text generated by the text generation model. In some examples, training component 215 generates a brand consistency value based on the language and the brand consistency data, where the parameters of the text generation model are updated based on the brand consistency value. In some examples, training component 215 trains the moderation model 245 (e.g., a brand moderation model) to evaluate images or text for brand consistency based on the brand consistency data. In some examples, training component 215 trains the image selection model 240 to evaluate images depicting the product.

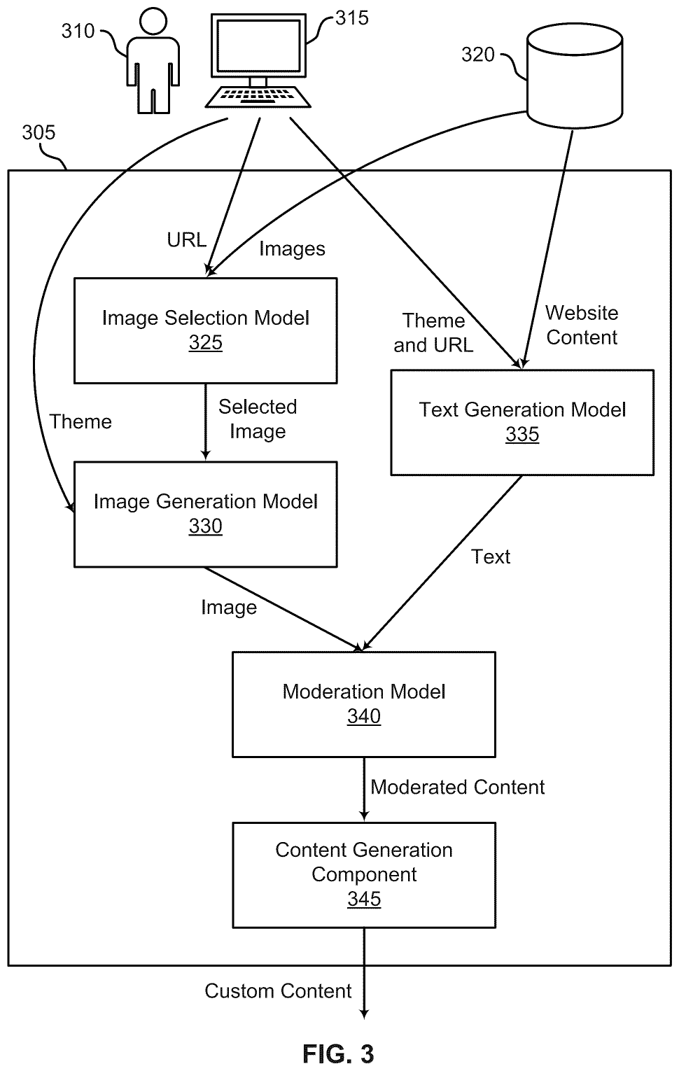

FIG. 3 shows an example of communications between components of a content generation system according to aspects of the present disclosure. A content generation system includes a content generation apparatus 305, a user 310, a user device 315, and a database 320. The content generation apparatus 305 includes an image selection model 325, an image generation model 330, a text generation model 335, a moderation model 340, and a content generation component 345. The user 310 provides a theme for custom content and a URL that includes images and text that can be included in the custom content. In some examples, the user 310 provides the theme and the URL to a content generation apparatus 305 via the user device 315. The content generation apparatus 305 then generates custom content for the user 310 based on the theme and the URL.

The image selection model 325 and the image generation model 330 of the content generation apparatus 305 coordinates to generate an image for the custom content for the user 310. The image selection model 325 receives an indication of the URL from the user 310, identify images on display at the URL, and retrieve the images from the database 320. The image selection model 325 then selects an image from the retrieved images, and the image selection model 325 passes the selected image to the image generation model 330. The image generation model 330 receives an indication of the theme from the user 310, and the image generation model 330 modifies the image received from the image selection model 325 (e.g., change a background of the image) based on the theme.

The text generation model 335 of the content generation apparatus 305 generates text for the custom content for the user 310. The text generation model 335 receives an indication of the theme and the URL from the user 310, identify website content on display at the URL, and retrieve the website content from the database 320. The text generation model 335 then generates text for the custom content for the user 310 based on the theme and the website content. In some examples, the text generation model 335 generates different types of text for the custom content. The text generation model 335 includes one or more models that generates the different types of text for the custom content (e.g., a different model for generating each different type of text).

The moderation model 340 of the content generation apparatus 305 moderates content generated by the image generation model 330 and the text generation model 335. The image generation model 330 passes the generated image to the moderation model 340, and the text generation model 335 passes the generated text to the moderation model 340. The moderation model 340 receives the image from the image generation model 330 and the text from the text generation model 335, and the moderation model 340 moderates the image and the text. For instance, the moderation model 340 verifies that the image and the text adhere to brand guidelines of a brand. Additionally, or alternatively, the moderation model 340 adapts the image and the text to adhere to the brand guidelines. In some examples, the moderation model 340 includes one or more models that moderates different attributes of images and text (e.g., a different model for moderating text, image style, or image content). The moderation model then passes the moderated content to the content generation component 345.

The content generation component 345 of the content generation apparatus 305 receives the moderated content from the moderation model 340, and the content generation component 345 generates custom content based on the moderated content. For example, the content generation component 345 combines the image from the image generation model 330 and the text from the text generation model 335 to generate the custom content. In some examples, the content generation component 345 generates the custom content before moderation, and the moderation model 340 moderates the custom content generated by the content generation component 345.

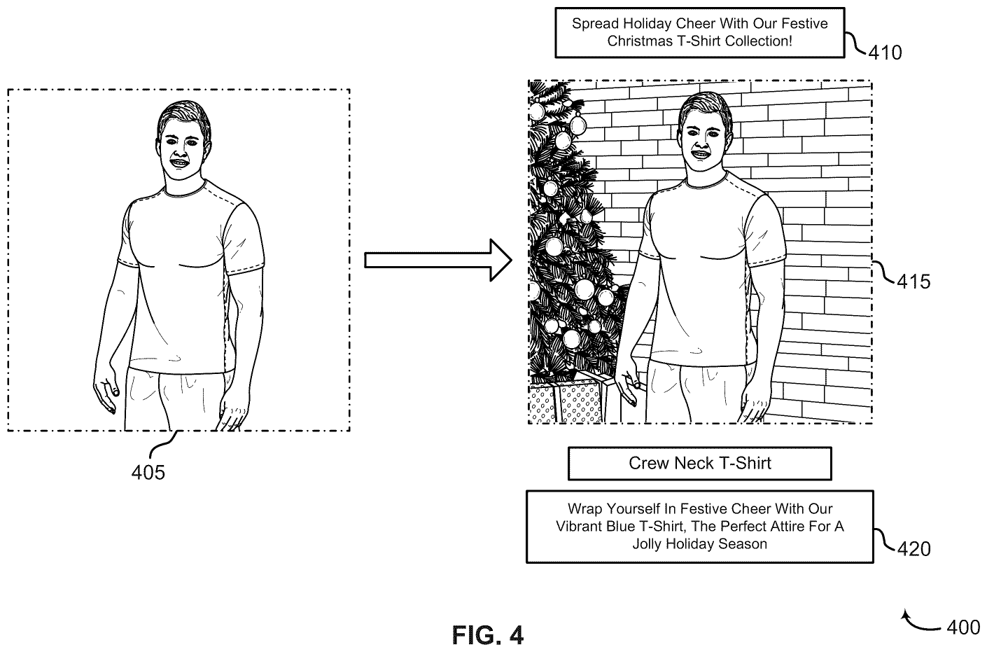

FIG. 4 shows an example of content generation according to aspects of the present disclosure. In the example of FIG. 4, a content provider at an apparel company wants to create an email campaign to send an email to customers who recently viewed a product (e.g., a T-shirt) on a website. The content provider decides to send the email around the holidays, so the content provider wants to add a festive touch to the email. The email features the product in a theme appropriate for the holidays. The content provider starts with a landing page to which to direct traffic, an approved template, and the theme (e.g., holiday theme). The content provider then uses a content generation apparatus to generate an email to send to customers based on the landing page, the approved template, and the theme.

The content generation apparatus takes the landing page, the approved template, and the theme as inputs, and the content generation apparatus generates custom content based on the inputs. The custom content features a product and includes a subject line 410, a hero image 415, and a one-line product summary 420. In some examples, the content generation apparatus generates the subject line 410 based on the theme. In some examples, the content generation apparatus selects a best image 405 from the landing page for the hero image 415, and the content generation apparatus adds holiday themes to the selected image 405 to generate the hero image 415. In some examples, the content generation apparatus generates the one-line product summary 420 based on the theme, product name, and product description extracted from the landing page.

The content generation apparatus also evaluates brand guidelines to ensure that custom content passes or satisfies brand safety rules. That is, the content generation apparatus determines that the custom content is consistent with a brand, and the content generation apparatus moderates the custom content as appropriate. If a content provider is not satisfied with generated content, the content provider simply requests additional renditions of the custom content from the content generation apparatus. A platform utilizing the content generation apparatus also allows for easy experimentation with different templates, products, and themes.

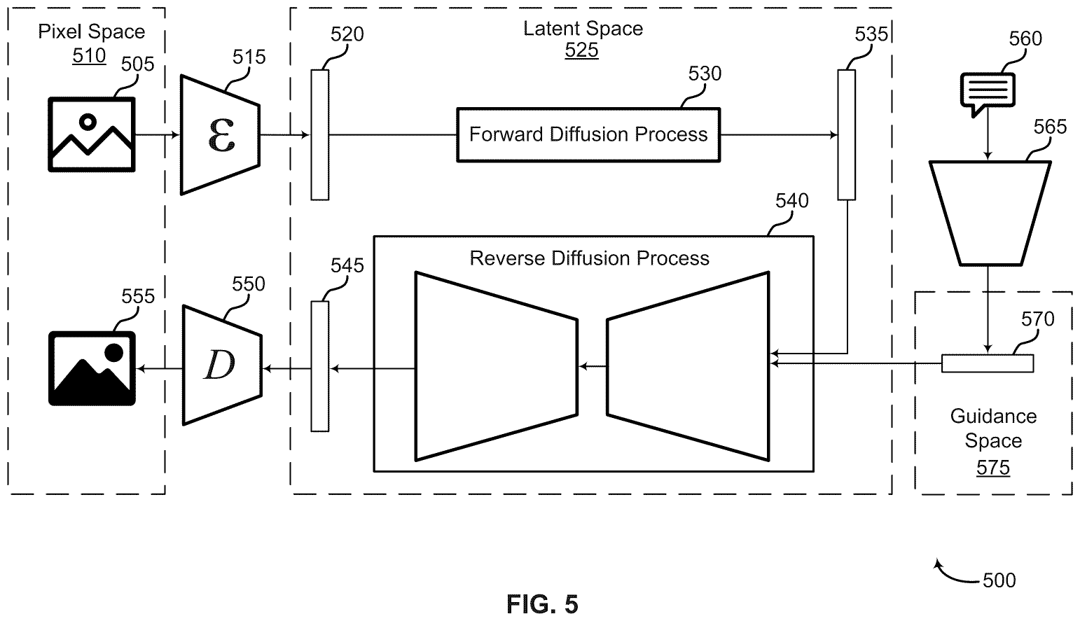

FIG. 5 shows an example of a guided latent diffusion model 500 according to aspects of the present disclosure. The guided latent diffusion model 500 is an example of, or includes aspects of, the image generation model 225 described with reference to FIG. 2. The guided latent diffusion model 500 generates a background of a product image based on a theme provided by a user.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text or other guidance), image inpainting, and image manipulation.

Types of diffusion models include DDPMs and DDIMs. In DDPMs, the generative process includes reversing a stochastic Markov diffusion process. DDIMs, on the other hand, use a deterministic and faster process so that the same input results in the same output. Diffusion models can also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 500 takes an original image 505 in a pixel space 510 as input and apply an image encoder 515 to convert original image 505 into original image features 520 in a latent space 525. Then, a forward diffusion process 530 gradually adds noise to the original image features 520 to obtain noisy features 535 (also in latent space 525) at various noise levels.

Next, a reverse diffusion process 540 (e.g., a U-Net ANN) gradually removes the noise from the noisy features 535 at the various noise levels to obtain denoised image features 545 in latent space 525. In some examples, the denoised image features 545 are compared to the image features 520 at each of the various noise levels, and parameters of the reverse diffusion process 540 of the diffusion model are updated based on the comparison. Finally, an image decoder 550 decodes the denoised image features 545 to obtain an output image 555 in pixel space 510.

In some cases, image encoder 515 and image decoder 550 are pre-trained prior to training the reverse diffusion process 540. In some examples, image encoder 515 and image decoder 550 are trained jointly, or the image encoder 515 and image decoder 550 are fine-tuned jointly with the reverse diffusion process 540.

The reverse diffusion process 540 can also be guided based on a text prompt 560, or another guidance prompt, such as an image, a layout, a segmentation map, etc. The text prompt 560 can be encoded using a text encoder 565 (e.g., a multimodal encoder) to obtain guidance features 570 in guidance space 575. The guidance features 570 can be combined with the noisy features 535 at one or more layers of the reverse diffusion process 540 to ensure that the output image 555 includes content described by the text prompt 560. For example, guidance features 570 can be combined with the noisy features 535 using a cross-attention block within the reverse diffusion process 540. In some examples, the guidance features 570 is based on negative prompts that indicate one or more parts of an image that should not change.

### Content Generation

In FIGS. 6 and 7, a method, apparatus, non-transitory computer-readable medium, and system for machine learning for content generation are described. One or more aspects of the method include identifying a theme, an audience, and an input image of a product; generating, for the audience, an output image depicting the product and the theme based on the input image using an image generation model that is trained to generate images consistent with a brand; generating text based on the product and the theme using a text generation model; and generating custom content consistent with the brand and the theme based on the output image and the text.

Some examples of the method, apparatus, non-transitory computer readable medium, and system further include obtaining, by an image selection model, a plurality of images of the product. Some examples further include selecting the input image from the plurality of images using the image selection model. Some examples of the method, apparatus, non-transitory computer readable medium, and system further include computing, by the image selection model, a coverage score. Some examples further include computing a compellingness score using the image selection model, wherein the input image is selected based on the coverage score and the compellingness score.

Some examples of the method, apparatus, non-transitory computer readable medium, and system further include identifying, by the image selection model, a product website, wherein the plurality of images are obtained from the product website. Some examples of the method, apparatus, non-transitory computer readable medium, and system further include identifying, by the content generation component, a document template, wherein the custom content is generated based on the document template. Some examples of the method, apparatus, non-transitory computer readable medium, and system further include transmitting, by the content generation apparatus, the custom content to a user in an email.

Some examples of the method, apparatus, non-transitory computer readable medium, and system further include identifying, by a moderation model, brand guidelines. Some examples further include determining, by the moderation model, whether the custom content is consistent with the brand based on the brand guidelines. In some aspects, the output image comprises a custom background based on the theme. In some aspects, the text comprises a subject line, a catchphrase, a product summary, or any combination thereof.

In the example content generation processes or methods described with reference to FIGS. 6 and 7, a content generation apparatus utilizes generative text and vision models to create content quickly. In an example, content providers uses the content generation apparatus to produce multiple versions of an email for an email campaign until the content providers are satisfied with the outcome. The content generation apparatus seamlessly combines advanced generative vision and text (e.g., language) capabilities to create effective, custom content (e.g., an effective email campaign). For instance, the content generation apparatus uses individual models for generating text or image fragments to generate custom content, such as content collaterals. The custom content consists of various components, such as a subject line, a hero image, a catchphrase, an email body, and a call-to-action button. These components align with a selected theme and reflect the creative style of a brand.

The content generation apparatus fine-tunes generative models to the creative style of a brand and combines these generative models to generate suitable custom content (e.g., an efficient email campaign). For instance, the content generation apparatus includes generative text and visual models (e.g., in a pipeline) that are fine-tuned to align with the creative style of a brand. The generative text and visual (e.g., vision) models in an implementation of the content generation apparatus includes one or more generative models. However, these models is replaceable components that can be swapped out with other models in other implementations of the content generation apparatus.

In an example, the content generation apparatus is used to generate custom content for an email. In this example, the content generation apparatus is used for subject line generation, catchphrase generation, product summary generation, selection of a hero image from product images featured on a landing page, and adaptation of a background of the hero image to match a campaign theme. The content generation apparatus facilitates task-specific fine-tuning of large language models to reflect the creative style of a brand. The content generation apparatus is configured to select a hero image to represent a product from a set of images based on how compelling each of the images are (e.g., a compellingness of each of the images) and based on a level of coverage of the product in each of the images.

Because the content generation apparatus combines the generation of various components (e.g., subject line, catchphrase, product summary, and hero image) into a template to generate content, the content generation apparatus allows for fast (e.g., one click) generation of custom content for an email campaign. Further, because the content generation apparatus automatically moderates custom content based on predefined brand guidelines, content providers is able to use the output of the content generation apparatus with limited or no post processing.

FIG. 6 shows an example of a method 600 for content generation according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, a user provides a theme and an image source to a content generation apparatus. The image source (e.g., a landing page URL) corresponds to a product listing, and the theme corresponds to a preferred theme for an email content campaign. In some cases, the operations of this step refer to, or is performed by, a user as described with reference to FIG. 1.

At operation 610, the content generation apparatus selects an image of a product. The image is referred to as a hero image, and the content generation apparatus selects the hero image from images at the image source (e.g., on a landing page). The content generation apparatus selects a hero image that appears compelling to a consumer (e.g., customer) and that provides adequate coverage of a product (e.g., a listed product being advertised). In some cases, the operations of this step refer to, or is performed by, an image selection model as described with reference to FIG. 2. The image selection model retrieves a product name and images from the image source and rank them based on a scoring system that assesses coverage and compellingness.

To assess coverage, the image selection model computes (e.g., using a multimodal encoder) a similarity score of images with a product name as a proxy for coverage of the product in the image. For instance, the image selection model generates a text embedding for a product name and generate an image embedding for each product image, and the image selection model assigns a similarity score to each image based on comparing the text embedding to the image embedding. Images with a higher similarity score is more likely to be included in custom content. For a product named “luxurious Italian wool blazer,” a higher similarity score indicates that a trench coat is well represented in the image. If a blazer is partially visible in an image or is photographed from the back in the image and therefore indistinguishable from a trench coat or jacket, the similarity score assigned to the image is low.

To assess compellingness, the image selection model leverages a model trained contrastively for deciphering between two different images which are unequally compelling as perceived on social media. For instance, the image selection model compares each image retrieved from the image source to each other image retrieved from the image source to determine which of the images is most compelling. Images that are more compelling is more likely to be included in custom content. The level of compellingness as perceived on social media is referred to as the intrinsic image popularity.

Once the image selection model identifies a similarity score for each image and a compellingness score for each image, the image selection model selects an image based on the similarity score and the compellingness score for each image. For instance, the image selection model determines a final score for each image by taking a product of the similarity score for each image and the compellingness score for each image. The image selection model then selects an image with the highest final score as the hero image to include in custom content.

At operation 615, the content generation apparatus generates custom content consistent with a brand and a theme. The custom content includes text generated by the content generation apparatus and the image selected by the image generation apparatus. In some cases, the operations of this step refer to, or is performed by, a content generation component as described with reference to FIG. 2.

An image generation model of the content generation apparatus customizes a background of the selected hero image to resonate with the theme (e.g., a campaign theme). For instance, the image generation model first identifies a background mask of the hero image. The image generation model applies salient object detection (e.g., using a U2_Net model) on a hero image and inverts a mask to obtain a background mask of the hero image. The image generation model then in-paints the background of the hero image (e.g., using diffusion). The image generation model uses a diffusion inpainting model to inpaint a background of a hero image to resonate with a campaign theme. The diffusion inpainting component takes the hero image, background mask, and a text prompt as input and, after performing a specified number of inference steps, and returns the hero image with a modified background while keeping salient objects in the hero image intact.

The text prompt for generating or modifying the hero image is selected to accurately reflect a campaign theme. Prompt engineering is performed on an open-source prompt database to choose a text prompt. A carefully chosen negative text prompt is used with diffusion to aid in the generation of a high-quality image. The image generation model also upscales the hero image once the background is modified. In some examples, the image generation model uses a text-guided latent upscaling diffusion model to upscale a generated image (e.g., to 2048×2048) since a highest resolution produced by diffusion is limited (e.g., to 768×768).

At operation 620, the content generation apparatus provides the custom content to consumers. In some cases, the operations of this step refer to, or is performed by, a content generation apparatus as described with reference to FIG. 2.

In some examples, the content generation apparatus moderates the custom content based on a brand for which the custom content is generated. The content generation apparatus determines whether generated content is consistent with a brand (e.g., appropriate or suitable for the brand). For instance, the content generation apparatus evaluates colors, tones, objects, faces, and more in generated content to determine whether the generated content is consistent with a brand (e.g., since some colors, tones, objects, and faces is prohibited from content generated for a brand). The content generation apparatus then adapts each generated text block (e.g., subject line, product description, catchphrase) and a generated image when appropriate. In some examples, the various models of the content generation apparatus is fine-tuned to be consistent with the brand.

In some examples, the content generation apparatus is provided with brand consistency data to use to determine if generated content is consistent with a brand or to use to train models to generate content that is consistent with the brand. The brand consistency data includes brand guidelines or examples of content that is suitable for a brand. Content is said to be consistent with a brand if the content passes, satisfies, or follows a set of brand guidelines provided for a brand, or content is said to be consistent with a brand if the content is similar to content that is previously determined to be suitable for the brand.

FIG. 7 shows an example of a method 700 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system identifies a theme, an audience, and an input image of a product. The theme corresponds to a preferred theme provided by a user for an email content campaign, and the input image of the product is selected from a set of product images retrieved from an image source (e.g., a landing page URL). In some cases, the operations of this step refer to, or is performed by, a content generation apparatus as described with reference to FIGS. 1 and 2.

At operation 710, the system generates, for the audience, an output image depicting the product and the theme based on the input image using an image generation model that is trained to generate images consistent with a brand. In some examples, the output image is generated by modifying the background of the input image to align with the theme. In some cases, the operations of this step refer to, or is performed by, an image generation model as described with reference to FIG. 2.

At operation 715, the system generates text based on the product and the theme using a text generation model. In some examples, the text includes a summary of the product, a subject line introducing the product, a catchphrase for the product, or any description of the product that ties in the theme. In some cases, the operations of this step refer to, or is performed by, a text generation model as described with reference to FIG. 2.

At operation 720, the system generates custom content consistent with the brand and the theme based on the output image and the text. In some examples, the custom content includes an email for an email content campaign, and the email includes the output image and the text that incorporates the theme. In some cases, the operations of this step refer to, or is performed by, a content generation component as described with reference to FIG. 2.

### Training

In FIGS. 8-10, a method, apparatus, non-transitory, computer-readable medium, and system for machine learning for content generation are described. One or more aspects of the method include obtaining training data including brand consistency data; generating an output image depicting a product using an image generation model; and updating parameters of the image generation model based on the brand consistency data and the output image.

For example, in some embodiments the image generation model is trained by computing a loss function that measures the brand consistency of output images based on the brand consistency data. Parameters of the model are updated based on the loss function, and the process is repeated until the image generation model is trained to output images that satisfy the brand guidelines.

Some examples of the method, apparatus, non-transitory computer readable medium, and system further include identifying a color in the output image (e.g., and other parameters in the output image, such as composition rules). Some examples further include generating a brand consistency value based on the color (e.g., and the other parameters) and the brand consistency data, wherein the parameters of the image generation model are updated based on the brand consistency value.

Some examples of the method, apparatus, non-transitory computer readable medium, and system further include identifying an object in the output image. Some examples further include generating a brand consistency value based on the object and the brand consistency data, wherein the parameters of the image generation model are updated based on the brand consistency value.

Some examples of the method, apparatus, non-transitory computer readable medium, and system further include identifying a theme, wherein the output image is generated based on the theme.

Some examples of the method, apparatus, non-transitory computer readable medium, and system further include training a text generation model to generate text based on the product and the theme.

Some examples of the method, apparatus, non-transitory computer readable medium, and system further include identifying language in output text generated by the text generation model. Some examples further include generating a brand consistency value based on the language and the brand consistency data, wherein the parameters of the text generation model are updated based on the brand consistency value.

Some examples of the method, apparatus, non-transitory computer readable medium, and system further include training a brand moderation model to evaluate images or text for brand consistency based on the brand consistency data.

Some examples of the method, apparatus, non-transitory computer readable medium, and system further include training an image selection model to evaluate images depicting the product.

FIG. 8 shows an example of a method 800 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including brand consistency data. The training data includes images and text for training one or more models of a content generation apparatus to generate content. In some cases, the operations of this step refer to, or is performed by, a training component as described with reference to FIG. 2.

At operation 810, the system generates an output image depicting a product using an image generation model. The system modifies an input image depicting the product to generate the output image, and the output image includes features (e.g., a background) incorporating a theme. In some cases, the operations of this step refer to, or is performed by, an image generation model as described with reference to FIG. 2.

At operation 815, the system updates parameters of the image generation model based on the brand consistency data and the output image. In particular, the system updates parameters of the image generation model based on comparing the output image to a training image that is consistent with a brand and incorporates a theme. In some cases, the operations of this step refer to, or is performed by, a training component as described with reference to FIG. 2.

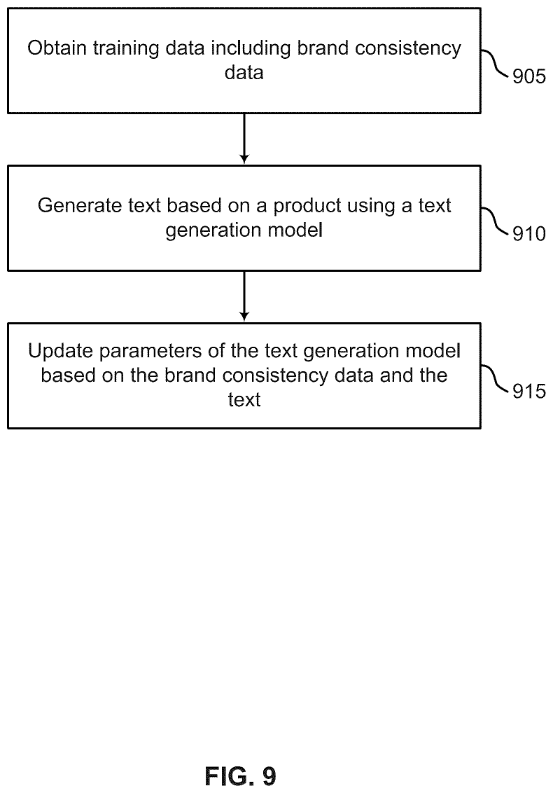

FIG. 9 shows an example of a method 900 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains training data including brand consistency data. The training data includes images and text for training one or more models of a content generation apparatus to generate content. In some cases, the operations of this step refer to, or is performed by, a training component as described with reference to FIG. 2.

At operation 910, the system generates text based on a product using a text generation model. In some examples, the text includes a summary of the product, a subject line introducing the product, a catchphrase for the product, or any description of the product that ties in a theme. In some cases, the operations of this step refer to, or is performed by, a text generation model as described with reference to FIG. 2.

At operation 915, the system updates parameters of the text generation model based on the brand consistency data and the text. In particular, the system updates parameters of the text generation model based on comparing the text to training text that is consistent with a brand and incorporates a theme (e.g., training text generated by another large language model). In some cases, the operations of this step refer to, or is performed by, a training component as described with reference to FIG. 2.

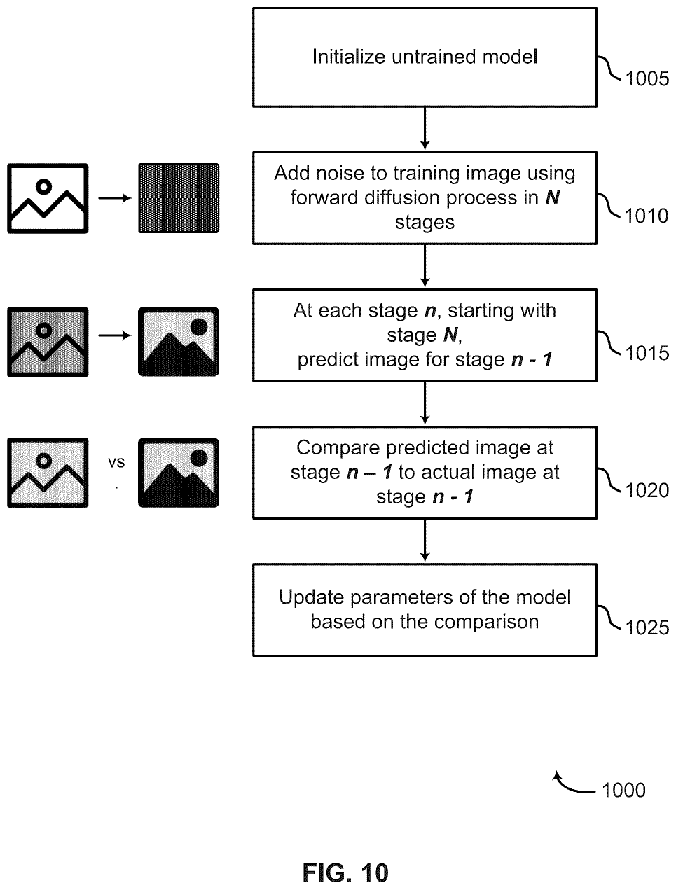

FIG. 10 shows an example of a method 1000 for training a diffusion model according to aspects of the present disclosure. The method 1000 represents an example for training a reverse diffusion process. In some examples, these operations are performed by a system including a processor executing a set of codes to control functional elements of an apparatus, such as the content generation apparatus described in FIG. 2.

Additionally, or alternatively, certain processes of method 1000 is performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

At operation 1010, the system adds noise to a training image using a forward diffusion process in N stages. In some cases, the forward diffusion process is a fixed process where Gaussian noise is successively added to an image. In latent diffusion models, the Gaussian noise is successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model is trained to minimize the variational upper bound of the negative log-likelihood-log p_{θ}(x) of the training data.

At operation 1025, the system updates parameters of the model based on the comparison. For example, parameters of a U-Net is updated using gradient descent. Time-dependent parameters of the Gaussian transitions can also be learned.

The description and drawings described herein represent example configurations and do not represent all the implementations within the scope of the claims. For example, the operations and steps is rearranged, combined or otherwise modified. Also, structures and devices is represented in the form of block diagrams to represent the relationship between components and avoid obscuring the described concepts. Similar components or features that have the same name may have different reference numbers corresponding to different figures.

Some modifications to the disclosure are readily apparent to those skilled in the art, and the principles defined herein is applied to other variations without departing from the scope of the disclosure. Thus, the disclosure is not limited to the examples and designs described herein but is to be accorded the broadest scope consistent with the principles and novel features disclosed herein.

The described methods is implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor is a microprocessor, a conventional processor, controller, microcontroller, or state machine. A processor can also be implemented as a combination of computing devices (e.g., a combination of a DSP and a microprocessor, multiple microprocessors, one or more microprocessors in conjunction with a DSP core, or any other such configuration). Thus, the functions described herein is implemented in hardware or software and is executed by a processor, firmware, or any combination thereof. If implemented in software executed by a processor, the functions is stored in the form of instructions or code on a computer-readable medium.

Computer-readable media includes both non-transitory computer storage media and communication media including any medium that facilitates transfer of code or data. A non-transitory storage medium is any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components is properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” is based on both condition A and condition B. In other words, the phrase “based on” shall be construed to mean “based at least in part on.” Also, the words “a” or “an” indicate “at least one.”

What is claimed is:

1. A method comprising:
identifying, by a content generation apparatus, a theme, an audience, and an input image of a product;
generating, for the audience, an output image depicting the product and the theme based on the input image using an image generation model that is trained to generate images consistent with a brand;
generating text based on the product and the theme using a text generation model; and
generating, by a content generation component, custom content consistent with the brand and the theme based on the output image and the text.

2. The method of claim 1, further comprising:
obtaining, by an image selection model, a plurality of images of the product; and
selecting the input image from the plurality of images using the image selection model.

3. The method of claim 2, further comprising:
computing, by the image selection model, a coverage score; and
computing a compellingness score using the image selection model, wherein the input image is selected based on the coverage score and the compellingness score.

4. The method of claim 2, further comprising:
identifying, by the image selection model, a product website, wherein the plurality of images is obtained from the product website.

5. The method of claim 1, further comprising:
identifying, by the content generation component, a document template, wherein the custom content is generated based on the document template.

6. The method of claim 1, wherein:
the an image generation model comprises a diffusion model and the content generation component comprises a transformer model.

7. The method of claim 1, further comprising:
identifying, by a moderation model, brand guidelines; and
determining, by the moderation model, whether the custom content is consistent with the brand based on the brand guidelines.

8. The method of claim 1, wherein:
the output image comprises a custom background based on the theme.

9. The method of claim 1, wherein:
the text comprises a subject line, a catchphrase, a product summary, or any combination thereof.

10. A method comprising:
obtaining, by a training component, training data including brand consistency data;
generating an output image depicting a product using an image generation model; and
updating, by the training component, parameters of the image generation model based on the brand consistency data and the output image.

11. The method of claim 10, further comprising:
identifying, by the training component, a color in the output image; and
generating, by the training component, a brand consistency value based on the color and the brand consistency data, wherein the parameters of the image generation model are updated based on the brand consistency value.

12. The method of claim 10, further comprising:
identifying, by the training component, an object in the output image; and
generating, by the training component, a brand consistency value based on the object and the brand consistency data, wherein the parameters of the image generation model are updated based on the brand consistency value.

13. The method of claim 10, further comprising:
identifying, by the image generation model, a theme, wherein the output image is generated based on the theme.

14. The method of claim 13, further comprising:
training, by the training component, a text generation model to generate text based on the product and the theme.

15. The method of claim 14, further comprising:
identifying, by the training component, language in output text generated by the text generation model; and
generating, by the training component, a brand consistency value based on the language and the brand consistency data, wherein the parameters of the text generation model are updated based on the brand consistency value.

16. The method of claim 10, further comprising:
training, by the training component, a brand moderation model to evaluate images or text for brand consistency based on the brand consistency data; and
training, by the training component, an image selection model to evaluate images depicting the product.

17. A system comprising:
at least one memory component;
at least one processing device coupled to the at least one memory component, wherein the processing device is configured to execute instructions stored in the at least one memory component;
an image generation model including parameters stored in the at least one memory component and configured to generate an output image depicting a product and a theme, wherein the image generation model comprises a diffusion model trained to generate images consistent with a brand; and
a text generation model including parameters stored in the at least one memory component, wherein the text generation model comprises a transformer model configured to generate text based on the product and the theme.

18. The system of claim 17, further comprising:
a content generation component configured to generate custom content consistent with the brand and the theme based on the output image and the text.

19. The system of claim 17, further comprising:
an image selection model configured to select an input image of the product from a plurality of images, wherein the output image is generated based on the input image.

20. The system of claim 17, further comprising:
a moderation model configured to identify brand guidelines and determine whether the text or the image is consistent with the brand based on the brand guidelines.
